(19) United States
(12) Patent Application Publication
(10) Pub. No.: US 2025/0197260 A1
(43) Pub. Date: Jun. 19, 2025

(54) PHOSPHORUS-CONTAINING WATER TREATMENT METHOD AND PHOSPHORUS-CONTAINING WATER TREATMENT DEVICE

(71) Applicant: ORGANO CORPORATION, Tokyo (JP)

(72) Inventors: Nanami IWASAKI, Tokyo (JP); Masaki MIYAKE, Tokyo (JP); Yoshiaki HASEBE, Tokyo (JP)

(73) Assignee: ORGANO CORPORATION, Tokyo (JP)

(21) Appl. No.: 18/975,148

(22) Filed: Dec. 10, 2024

(30) Foreign Application Priority Data
Dec. 13, 2023 (JP) 2023-210602

(51) Int. Cl. C02F 3/00; C02F 3/30; C02F 101/10

(52) U.S. Cl. CPC C02F 3/006; C02F 3/308; C02F 2101/105; C02F 2209/001

(57) ABSTRACT

A phosphorus-containing water treatment method includes a continuous water flow biological treatment step of subjecting phosphorus-containing water to biological treatment using biological sludge while continuously feeding the phosphorus-containing water to a continuous biological treatment tank; a granule sludge formation step of forming granule sludge in a semi-batch biological treatment tank; and a sludge supply step of supplying the granule sludge formed in the semi-batch biological treatment tank to the continuous biological treatment tank through a sludge supply pipe. In the sludge supply step, the supply volume of granule sludge which is to be supplied to the continuous biological treatment tank is controlled based on the phosphorus removal performance in the continuous biological treatment tank.

### CROSS REFERENCE TO RELATED APPLICATION

This application claims priority to Japanese Patent Application No. 2023-210602 filed on Dec. 13, 2023, which is incorporated herein by reference in its entirety including the specification, claims, drawings, and abstract.

### TECHNICAL FIELD

The present disclosure relates to the art of phosphorus-containing water treatment methods and phosphorus-containing water treatment devices.

### BACKGROUND

Conventionally, biological water treatment has employed an activated sludge process that utilizes an aggregate of microorganisms (an aerobic biological sludge) known as a floc. An activated sludge process can remove not only organic matter or nitrogen but also phosphorus from water.

For example, Patent Document 1 discloses a wastewater treatment device that includes a membrane separation device, wherein a partition plate is disposed above the membrane separation device. With the structure disclosed in Patent Document 1, nitrogen and phosphorus are simultaneously removed from sewage.

Patent Document 2 discloses a method comprising subjecting inflow sewage to solid-liquid separation into separated water and separated sludge; causing the separated water to be introduced into a biological treatment tank where it is treated; and concentrating the separated sludge using a concentrator to feed the concentrated separated liquid containing organic matter to a biological reactor.

Patent Document 3 discloses a method of removing nitrogen and phosphorus from wastewater by performing intermittent aeration treatment using a first aeration tank and a second aeration tank that are connected in series.

### CITATION LIST

### Patent Literature

Patent Document 1: JP 2022-57310 A
Patent Document 2: JP 2012-24725 A
Patent Document 3: JP H09-94596 A

### SUMMARY

However, during biological treatment of phosphorus-containing water, phosphorus removal performance may drop when, for example, the phosphorus concentration in the phosphorus-containing water varies due to, for example, rainfall, thus causing a problem in that in this case, it takes a long time until recovery of the phosphorus removal performance. To address this situation, the present disclosure is directed toward providing a phosphorus-containing water treatment method and a phosphorus-containing water treatment device that enable quick recovery of the phosphorus removal performance.

According to an aspect of the present disclosure, there is provided a phosphorus-containing water treatment method comprising a continuous water flow biological treatment step of subjecting phosphorus-containing water to biological treatment using biological sludge while continuously feeding the phosphorus-containing water to a continuous biological treatment tank; a granule sludge formation step of forming granule sludge; and a sludge supply step of supplying the granule sludge formed in the granule sludge formation step to the continuous biological treatment tank. In the sludge supply step, a supply volume of granule sludge which is to be supplied to the continuous biological treatment tank is controlled based on phosphorus removal performance in the continuous biological treatment tank.

Preferably, in the phosphorus-containing water treatment method, the supply volume of granule sludge which is to be supplied to the continuous biological treatment tank per day is determined based on the phosphorus removal performance in the continuous biological treatment tank within a past predetermined period and a supply volume of granule sludge which has been supplied to the continuous biological treatment tank per day within the past predetermined period.

Preferably, in the phosphorus-containing water treatment method, during deterioration or estimated deterioration in phosphorus removal performance in the continuous biological treatment tank, the supply volume of granule sludge which is to be supplied to the continuous biological treatment tank is increased to be greater than during improvement in phosphorus removal performance in the continuous biological treatment tank.

Preferably, in the phosphorus-containing water treatment method, the supply volume of granule sludge which is to be supplied to the continuous biological treatment tank per day is set based on the phosphorus removal performance in the continuous biological treatment tank in a range of 0-fold to 20-fold the supply volume of granule sludge which has been supplied to the continuous biological treatment tank per day on a preceding day.

According to another aspect of the present disclosure, there is provided a phosphorus-containing water treatment device comprising a continuous biological treatment tank configured to subject phosphorus-containing water to biological treatment using biological sludge while continuously feeding the phosphorus-containing water; granule sludge forming means for forming granule sludge; sludge supply means for supplying the granule sludge formed in the granule sludge forming means to the continuous biological treatment tank; and control means for controlling a supply volume of granule sludge which is to be supplied to the continuous biological treatment tank by the sludge supply means based on phosphorus removal performance in the continuous biological treatment tank.

Preferably, in the phosphorus-containing water treatment device, the control means determines the supply volume of granule sludge which is to be supplied to the continuous biological treatment tank per day based on the phosphorus removal performance in the continuous biological treatment tank within a past predetermined period and a supply volume of granule sludge which has been supplied to the continuous biological treatment tank per day within the past predetermined period.

Preferably, in the phosphorus-containing water treatment device, during deterioration or estimated deterioration in phosphorus removal performance in the continuous biological treatment tank, the control means increases the supply volume of granule sludge which is to be supplied to the continuous biological treatment tank to be greater than during improvement in phosphorus removal performance in the continuous biological treatment tank.

Preferably, in the phosphorus-containing water treatment device, the control means sets the supply volume of granule sludge which is to be supplied to the continuous biological treatment tank per day based on the phosphorus removal performance in the continuous biological treatment tank in a range of 0-fold to 20-fold the supply volume of granule sludge which has been supplied to the continuous biological treatment tank per day on a preceding day.

The present disclosure provides a phosphorus-containing water treatment method and a phosphorus-containing water treatment device that enable quick recovery of the phosphorus removal performance.

### BRIEF DESCRIPTION OF DRAWINGS

Embodiments of the present disclosure will be described based on the following figures, wherein:

FIG. 1 is a schematic diagram illustrating an example configuration of a phosphorus-containing water treatment device according to an embodiment of the present disclosure; and

FIG. 2 is a graph illustrating the transitions in phosphorus concentration in simulated wastewater, phosphorus concentration in treated water discharged from a continuous biological treatment tank, and phosphate phosphorus concentration in an anaerobic tank as measured during a test period in an Example.

### DESCRIPTION OF EMBODIMENTS

Embodiments of the present disclosure will be described below. It should be noted that the embodiments described herein are merely example embodiments of the present disclosure, and the present disclosure is not limited to these embodiments.

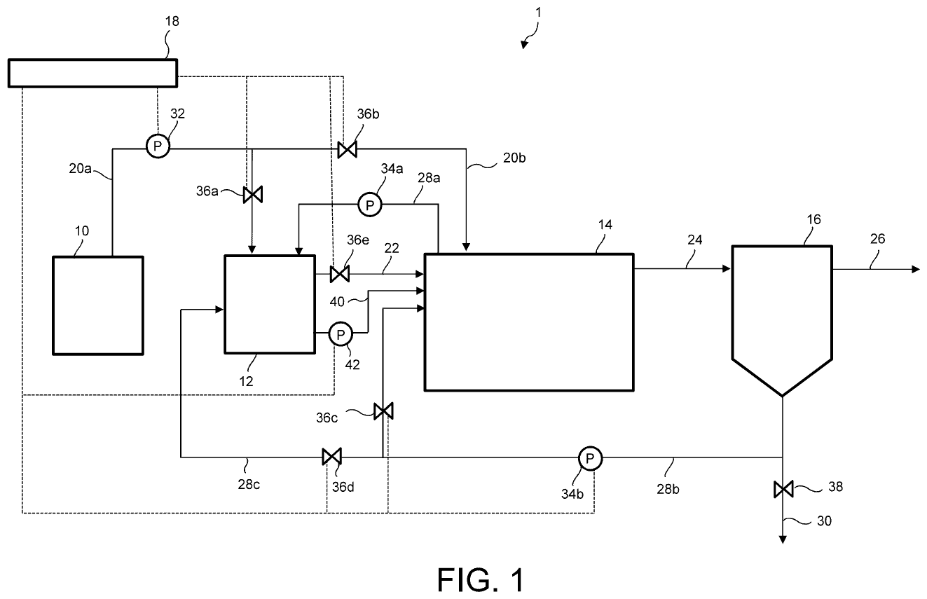

FIG. 1 is a schematic diagram illustrating an example configuration of a phosphorus-containing water treatment device according to an embodiment of the present disclosure. Referring to FIG. 1, the phosphorus-containing water treatment device 1 includes a raw water tank 10, a semi-batch biological treatment tank 12, a continuous biological treatment tank 14, a sedimentation tank 16, and a control device 18. In this description, the term “continuous” refers to a method which is in contrast to a batch method, and which is distinct from semi-batch treatment in which feeding of water to be treated, biological treatment, settling of sludge, and discharging of treated water are performed in a single tank, as in a semi-batch method. Although phosphorus-containing water is continuously supplied to the continuous biological treatment tank 14, the method is not limited to a method for operation in which phosphorus-containing water is introduced into the tank continuously, but may be, for example, a method for operation in which phosphorus-containing water is supplied to the tank using a pump that works on a principle such as reciprocating motion, such as a diaphragm pump, or may be, for example, a simulated continuous water flow method in which phosphorus-containing water is supplied to the tank by controlling a pump to operate or stop in accordance with the water level in the raw water tank 10, which is installed before the tank (when the water level is high, the pump is controlled to operate, and when the water level is low, the pump is controlled to stop).

Referring to FIG. 1, the phosphorus-containing water treatment device 1 includes water-to-be-treated pipes (20a, 20b), a first treated water pipe 22, a second treated water pipe 24, a third treated water pipe 26, sludge return pipes (28a, 28b, 28c), a sludge discharge pipe 30, a water-to-be-treated pump 32, sludge return pumps (34a, 34b), electromagnetic valves (36a, 36b, 36c, 36d, 36e), a valve 38, a sludge supply pipe 40, and a sludge supply pump 42.

One end of the water-to-be-treated pipe 20a is connected to the raw water tank 10, and the other end is connected to the semi-batch biological treatment tank 12 via the water-to-be-treated pump 32 and the electromagnetic valve 36a. One end of the water-to-be-treated pipe 20b is connected to the water-to-be-treated pipe 20a, and the other end is connected to the continuous biological treatment tank 14 via the electromagnetic valve 36b. One end of the first treated water pipe 22 is connected to the semi-batch biological treatment tank 12, and the other end is connected to the continuous biological treatment tank 14 via the electromagnetic valve 36e. One end of the second treated water pipe 24 is connected to the continuous biological treatment tank 14, and the other end is connected to the sedimentation tank 16. The third treated water pipe 26 is connected to the sedimentation tank 16. One end of the sludge return pipe 28a is connected to the continuous biological treatment tank 14, and the other end is connected to the semi-batch biological treatment tank 12 via the sludge return pump 34a. One end of the sludge discharge pipe 30 is connected to the sedimentation tank 16. One end of the sludge return pipe 28b is connected to the sludge discharge pipe 30, and the other end is connected to the continuous biological treatment tank 14 via the sludge return pump 34b and the electromagnetic valve 36c. One end of the sludge return pipe 28c is connected to the sludge return pipe 28b, and the other end is connected to the semi-batch biological treatment tank 12 via the electromagnetic valve 36d.

One end of the sludge supply pipe 40 is connected to the semi-batch biological treatment tank 12, and the other end is connected to the continuous biological treatment tank 14 via the sludge supply pump 42.

In the phosphorus-containing water treatment device 1 illustrated in FIG. 1, the semi-batch biological treatment tank 12 serves as granule sludge forming means for forming granule sludge. In the semi-batch biological treatment tank 12, granule sludge is formed by performing an operation including an inflow step, a biological treatment step, a settling step, and a discharge step, as described below. The granule sludge forming means according to an embodiment of the present disclosure is not limited to the semi-batch biological treatment tank 12 in which the operation including the inflow step, the biological treatment step, the settling step, and the discharge step is performed, but may be any conventionally known device capable of forming granule sludge.

In the phosphorus-containing water treatment device 1 illustrated in FIG. 1, the sludge supply pipe 40 and the sludge supply pump 42 installed on the sludge supply pipe 40 serve as the sludge supply means for supplying granule sludge formed in the semi-batch biological treatment tank 12 to the continuous biological treatment tank 14. It should be noted that the sludge supply pipe 40 may optionally have an electromagnetic valve installed thereon.

The control device 18 includes, for example, a microcomputer composed of a CPU for operating programs and a ROM and a RAM for storing the programs and results of the operation, and electronic circuitry. The control device 18 reads a predetermined program stored in the ROM or the like and executes this program, thereby controlling the operation of the water treatment device 1. The control device 18 is electrically connected to the pumps and electromagnetic valves through, for example, wired or wireless connection and is configured to control the operation of the pumps and the opening and closing of the electromagnetic valves. The control device 18 serves as the control means for controlling the supply volume of granule sludge which is to be supplied to the continuous biological treatment tank 14 based on the phosphorus removal performance in the continuous biological treatment tank 14.

According to an embodiment of the present disclosure, an example operation of the phosphorus-containing water treatment device 1 will be described below. Phosphorus-containing water, which is to be treated, contains not only phosphorus but may also contain organic matter or the like. Examples of the phosphorus-containing water include, for example, food processing plant wastewater, chemical plant wastewater, semiconductor plant wastewater, machinery plant wastewater, sewage, human waste, river water, and other wastewater.

The control device 18 causes the water-to-be-treated pump 32 to operate or the electromagnetic valve 36b to open, so that phosphorus-containing water in the raw water tank 10 is continuously supplied to the continuous biological treatment tank 14 through the water-to-be-treated pipes 20a and 20b. In the continuous biological treatment tank 14, the phosphorus-containing water is subjected to biological treatment using biological sludge in the tank (continuous water flow biological treatment step). In the continuous biological treatment tank 14, the phosphorus-containing water may be subjected to biological treatment under aerobic conditions, or the phosphorus-containing water may be subjected to biological treatment under anaerobic conditions. The continuous biological treatment tank 14 may be, but is not limited to, a biological treatment tank that employs a standard activated sludge process, or may be a biological treatment system that employs, for example, an AO process or an A₂O process (such as an anaerobic-aerobic system or an anaerobic-anoxic-aerobic system) in that, for example, biological phosphorus removal can be performed efficiently. When a standard activated sludge process is employed, in terms of biological phosphorus removal, an operation method with a limited amount of aeration in a portion upstream of the continuous biological treatment tank 14 (simulated anaerobic-aerobic process) may be employed.

Treated water that has been subjected to biological treatment in the continuous biological treatment tank 14 is supplied through the second treated water pipe 24 to the sedimentation tank 16, in which biological sludge is separated from the treated water. The treated water from which biological sludge is separated is discharged through the third treated water pipe 26 to a position outside the system. Biological sludge deposited on the bottom of the sedimentation tank 16 is discharged through the sludge discharge pipe 30 to a position outside the system as the valve 38 is opened, or as the control device 18 causes the sludge return pump 34b to operate or the electromagnetic valve 36c or 36d to open, the biological sludge is returned to the continuous biological treatment tank 14 through the sludge return pipe 28b or is returned to the semi-batch biological treatment tank 12 through the sludge return pipe 28c. Alternatively, for example, the control device 18 may cause the sludge return pump 34a to operate, thereby returning biological sludge in the continuous biological treatment tank 14 to the semi-batch biological treatment tank 12 through the sludge return pipe 28a.

During operation of the semi-batch biological treatment tank 12, the control device 18 causes the electromagnetic valve 36a to open, thereby feeding some of the phosphorus-containing water to the semi-batch biological treatment tank 12 through the water-to-be-treated pipe 20a ((1) inflow step). After a predetermined amount of phosphorus-containing water flows into the semi-batch biological treatment tank 12, the electromagnetic valve 36a is closed to suspend the inflow step. In the semi-batch biological treatment tank 12, water to be treated is subjected to biological treatment using biological sludge ((2) biological treatment step). For example, in the semi-batch biological treatment tank 12, under aerobic conditions, organic matter in phosphorus-containing water is subjected to oxidative degradation using aerobic biological sludge or nitrogen compounds are subjected to nitrification treatment using biological sludge including nitrifying bacteria, or under anaerobic conditions, nitrogen compounds are subjected to denitrification treatment using biological sludge including denitrifying bacteria. With the biological treatment in the continuous biological treatment tank 14 being aerobic treatment, the biological treatment in the semi-batch biological treatment tank 12 may also be aerobic treatment, and with the biological treatment in the continuous biological treatment tank 14 being anaerobic treatment, the biological treatment in the semi-batch biological treatment tank 12 may also be anaerobic treatment.

After the above-described biological treatment step is performed for a predetermined duration of time, the inside of the tank is left at rest, allowing biological sludge in the semi-batch biological treatment tank 12 to settle for a predetermined duration of time ((3) settling step), so that the biological sludge and treated water are separated from each other. Subsequently, the control device 18 causes the electromagnetic valve 36e to open, so that supernatant water (treated water) in the semi-batch biological treatment tank 12 is discharged from the semi-batch biological treatment tank 12 ((4) discharge step) and supplied to the continuous biological treatment tank 14 through the first treated water pipe 22. By repeating the above-described steps (1) to (4), biological sludge in the semi-batch biological treatment tank 12 is granulated, forming granule sludge (granule sludge formation step). Note that the treatment in the semi-batch biological treatment tank 12 is not limited to the above-described embodiment in which the inflow step and the discharge step are performed separately, but in an embodiment, the discharge step may be performed while the inflow step is being performed. Referring, as an example, to the water treatment device 1 in FIG. 1, the control device 18 causes the electromagnetic valve 36a to open and the electromagnetic valve 36e to open, thereby feeding some of phosphorus-containing water through the water-to-be-treated pipe 20a into the semi-batch biological treatment tank 12 and discharging treated water from the semi-batch biological treatment tank 12 through the first treated water pipe 22 ((1) inflow step/discharge step). After a predetermined duration of time has elapsed, the electromagnetic valve 36a and the electromagnetic valve 36e are closed, and the phosphorus-containing water is subjected to biological treatment using biological sludge in the semi-batch biological treatment tank 12 ((2) biological treatment step). After the biological treatment step, the inside of the tank is left at rest, allowing biological sludge in the semi-batch biological treatment tank 12 to settle for a predetermined duration of time ((3) settling step), so that the biological sludge and treated water are separated from each other. By repeating the above-described steps (1) to (3), biological sludge in the semi-batch biological treatment tank 12 is granulated, forming granule sludge (granule sludge formation step). The granule sludge formed in the semi-batch biological treatment tank 12 is sludge that has undergone self-granulation, and is biological sludge having, for example, a sludge average particle size of 0.2 mm or greater, wherein sludge of 0.2 mm or greater is present with a percentage of 40% or greater. The particle size of granule sludge can be measured using, for example, a laser diffraction particle size measurement device or a sieve.

Although, in the water treatment device 1 of FIG. 1, treated water discharged from the semi-batch biological treatment tank 12 is supplied to the continuous biological treatment tank 14 through the first treated water pipe 22, the present disclosure is not limited to this embodiment. For example, the treated water may be directly discharged to a position outside the system without being supplied to the continuous biological treatment tank 14 or may be supplied to the sedimentation tank 16.

In the water treatment device 1 of FIG. 1, the control device 18 causes the sludge supply pump 42 to operate, thereby supplying the granule sludge formed in the semi-batch biological treatment tank 12 through the sludge supply pipe 40 to the continuous biological treatment tank 14 (sludge supply step). In this sludge supply step, the supply volume of granule sludge which is to be supplied to the continuous biological treatment tank 14 is controlled based on the phosphorus removal performance in the continuous biological treatment tank 14. For example, during deterioration in phosphorus removal performance in the continuous biological treatment tank 14, the control device 18 controls the operation of the sludge supply pump 42 to increase the supply volume of granule sludge from the semi-batch biological treatment tank 12 to the continuous biological treatment tank 14 to be greater than during improvement which is before the phosphorus removal performance deteriorates. The control device 18 may also control the operation of the sludge supply pump 42 after the phosphorus removal performance recovers in the continuous biological treatment tank 14 (in other words, during improvement in phosphorus removal performance) to reduce the supply volume of granule sludge to be less than during deterioration in phosphorus removal performance. Regarding the supply volume of granule sludge, increasing or reducing the supply volume of granule sludge per day is preferable, but the present disclosure is not limited to this example.

By controlling the supply volume of granule sludge from the semi-batch biological treatment tank 12 to the continuous biological treatment tank 14 based on the phosphorus removal performance in the continuous biological treatment tank 14 in this manner, the phosphorus removal performance in the continuous biological treatment tank 14 can be quickly recovered when the phosphorus removal performance in the continuous biological treatment tank 14 deteriorates. While the mechanism by which the above-described advantages are obtainable remains not fully elucidated, the following is conjectured.

Phosphorus in phosphorus-containing water is treated by bacteria with high phosphorus accumulating ability (“phosphorus accumulating bacteria”) contained in sludge. For example, the phosphorus accumulating bacteria take in organic matter and emit phosphorus under anaerobic conditions but, under aerobic conditions, capture a greater amount of phosphorus than the emitted phosphorus, thereby removing phosphorus from the phosphorus-containing water. Typically, granule sludge includes many phosphorus accumulating bacteria. In particular, as conditions that allow phosphorus accumulating bacteria to emit and capture phosphorus can be created in the semi-batch biological treatment tank 12 during the biological treatment step, it is believed that a greater number of phosphorus accumulating bacteria are found in granule sludge formed in the semi-batch biological treatment tank 12. In particular, aerobic conditions are provided through aeration during the biological treatment step, thereby enabling a greater number of phosphorus accumulating bacteria to be present in granule sludge. As the average particle size of granule sludge is large (for example, 0.2 mm or greater), resulting in an anaerobic state at the center of granule sludge, granule sludge has an environment in which phosphorus accumulating bacteria more easily emit or capture phosphorus than in ordinary activated sludge.

Typically, deterioration in phosphorus removal performance is significant when the phosphorus concentration in phosphorus-containing water decreases due to, for example, rainfall. This is attributable to the fact that, as the amount of phosphorus emission from phosphorus accumulating bacteria in the tank decreases, the phosphorus removal activity of the phosphorus accumulating bacteria decreases. Therefore, a decrease in phosphorus concentration in phosphorus-containing water may cause deterioration in phosphorus removal performance in the continuous biological treatment tank 14. However, in the semi-batch biological treatment tank 12, which has an environment in which phosphorus accumulating bacteria can exist easily as described above, as the influence of a decrease in phosphorus concentration in phosphorus-containing water upon the phosphorus removal performance is small, granule sludge having a high phosphorus removal activity can be formed. Therefore, when a change in phosphorus concentration in phosphorus-containing water has caused deterioration in phosphorus removal performance in the continuous biological treatment tank 14, the supply volume of granule sludge from the semi-batch biological treatment tank 12 to the continuous biological treatment tank 14 may be increased to be greater than during improvement before the phosphorus removal performance deteriorates, thereby enabling quick recovery of the phosphorus removal performance in the continuous biological treatment tank 14. After the phosphorus removal performance in the continuous biological treatment tank 14 has recovered, it is preferable to reduce the supply volume of granule sludge to be less than that during deterioration in phosphorus removal performance.

The phosphorus removal performance in the continuous biological treatment tank 14 may be determined based on, for example, the phosphorus concentration in the treated water. The phosphorus-containing water treatment device 1 in FIG. 1 includes, for example, a phosphorus concentration sensor installed on the second treated water pipe 24 to measure the phosphorus concentration in the treated water passing through the second treated water pipe 24 using the phosphorus concentration sensor. The control device 18 then controls the supply volume of granule sludge in the above-described manner by, for example, determining that improvement in phosphorus removal performance is underway when the phosphorus concentration measured by the phosphorus concentration sensor is less than or equal to a predetermined reference value, and determining that deterioration in phosphorus removal performance is underway when the phosphorus concentration measured by the phosphorus concentration sensor exceeds the predetermined reference value.

The phosphorus removal performance in the continuous biological treatment tank 14 may also be determined based on, for example, the oxidation-reduction potential (“ORP”) or the concentration of anaerobic emission of phosphorus at a predetermined position in the continuous biological treatment tank 14 in terms of the fact that, for example, the phosphorus removal performance in the continuous biological treatment tank 14 can be identified immediately. The measurement point of the ORP may be set at a location where the lowest ORP is found by obtaining a profile of the ORP in the continuous biological treatment tank 14 beforehand in a state in which good phosphorus removal is being performed (for example, the phosphate phosphorus concentration in the treated water is less than or equal to 1 mgP/L, or the total phosphorus removal percentage is greater than or equal to 90%). The control device 18 then controls the supply volume of granule sludge in the above-described manner by, for example, determining that improvement in phosphorus removal performance is underway when the ORP measured at the above-described location is less than or equal to a predetermined reference value and determining that deterioration in phosphorus removal performance is underway when the ORP measured at the above-described location exceeds the predetermined reference value. It should be noted that, if the continuous biological treatment tank 14 includes an anaerobic tank, the ORP in the anaerobic tank may be measured. The measurement point of the concentration of anaerobic emission of phosphorus may be set at a location where the highest phosphate phosphorus concentration is found (that is, a location where an increase in phosphorus concentration caused by phosphorus emission is the highest) by obtaining a profile of the phosphate phosphorus concentration in the continuous biological treatment tank 14 beforehand in a state in which good phosphorus removal is being performed. The control device 18 then controls the supply volume of granule sludge in the above-described manner by, for example, determining that improvement in phosphorus removal performance is underway when the phosphate phosphorus concentration measured at the above-described location exceeds a predetermined reference value and determining that deterioration in phosphorus removal performance is underway when the phosphate phosphorus concentration measured at the above-described location is less than or equal to the predetermined reference value. It should be noted that, if the continuous biological treatment tank 14 includes an anaerobic tank, the phosphate phosphorus concentration in the anaerobic tank may be measured.

In the phosphorus-containing water treatment device 1 illustrated in FIG. 1, during estimated deterioration in phosphorus removal performance in the continuous biological treatment tank 14, the control device 18 may control the operation of the sludge supply pump 42 to increase the supply volume of granule sludge from the semi-batch biological treatment tank 12 to the continuous biological treatment tank 14 to be greater than before the estimated deterioration in phosphorus removal performance (during improvement). Deterioration in phosphorus removal performance may be estimated based on, for example, forecast precipitation in weather forecasts. For example, the control device 18 communicates with a meteorological information server installed at the Japan Meteorological Agency or another organization handling meteorological information over a wired or wireless communication network, thereby obtaining a future precipitation forecast for an area from which phosphorus-containing water, which is to be treated, is discharged. When the obtained precipitation forecast indicates that the amount of precipitation after a predetermined duration of time (for example, one hour later) from the present time exceeds a preset reference value, the control device 18 then estimates that the phosphorus removal performance will deteriorate, thus increasing the supply volume of granule sludge. Such control avoids deterioration in phosphorus removal performance in the continuous biological treatment tank 14 beforehand, thereby enabling stable phosphorus treatment.

During deterioration or estimated deterioration in phosphorus removal performance in the continuous biological treatment tank 14, the supply volume of granule sludge to the continuous biological treatment tank 14 may be increased to be greater than or equal to double the supply volume of granule sludge during improvement, or alternatively the increase may be a 4% or greater increase relative to the granule sludge percentage in the continuous biological treatment tank 14 during improvement.

Preferably, the supply volume of granule sludge which is to be supplied to the continuous biological treatment tank 14 per day is determined based on the phosphorus removal performance in the continuous biological treatment tank 14 within a past predetermined period (the past predetermined period is a past predetermined period, such as one week, from the present time) and the supply volume of granule sludge which has been supplied to the continuous biological treatment tank 14 per day within the past predetermined period. For example, if the phosphorus removal performance was good during the past one week with no change in supply volume of granule sludge per day, the supply of granule sludge to the continuous biological treatment tank may be eliminated. The supply volume of granule sludge per day may be greater than or equal to 0.2% relative to the amount of sludge in the continuous biological treatment tank 14, and for more stable phosphorus removal performance, granule sludge may be supplied to be present with a percentage of greater than or equal to 2% in the sludge in the continuous biological treatment tank 14.

In terms of, for example, reducing deterioration in sludge properties in the continuous biological treatment tank 14, the supply volume of granule sludge which is to be supplied to the continuous biological treatment tank 14 per day may be set based on the phosphorus removal performance in the continuous biological treatment tank 14 in a range of 0-fold to 20-fold the supply volume of granule sludge which has been supplied to the continuous biological treatment tank 14 per day on the preceding day. For example, during deterioration or estimated deterioration in phosphorus removal performance in the continuous biological treatment tank 14, the supply volume of granule sludge which is to be supplied to the continuous biological treatment tank 14 per day may be set in a range of greater than 1-fold and less than or equal to 20-fold the supply volume of granule sludge which has been supplied to the continuous biological treatment tank per day on the preceding day or may be set in a range of greater than or equal to double and less than or equal to 20-fold the supply volume of granule sludge which has been supplied to the continuous biological treatment tank per day on the preceding day. For example, during improvement in phosphorus removal performance in the continuous biological treatment tank 14, the supply volume of granule sludge which is to be supplied to the continuous biological treatment tank 14 per day may be set in a range of greater than or equal to 0-fold and less than or equal to 1-fold the supply volume of granule sludge which has been supplied to the continuous biological treatment tank 14 per day on the preceding day. Such setting is performed by, for example, the control device 18.

After the supply volume of granule sludge to the continuous biological treatment tank 14 is increased, the supply volume of granule sludge may be reset to the original value when a trend toward recovery of the phosphorus removal performance in the continuous biological treatment tank 14 is observed. For example, the supply of an increased amount of granule sludge is continued until an increase in phosphate phosphorus concentration measured at the above-described measurement point in the continuous biological treatment tank 14 is observed, and subsequently, when an increase in phosphate phosphorus concentration is observed, it is determined that the trend is toward recovery of the phosphorus removal performance, and the supply volume of granule sludge is reset to the original value. Whether or not there is a trend toward recovery of the phosphorus removal performance is determined not only based on the phosphate phosphorus concentration but may also be determined based on, for example, the ORP described above or the phosphorus concentration in the treated water.

The semi-batch biological treatment tank 12 may be operated with an MLSS concentration in a range of 2000 to 20000 mg/L. To maintain the integrity (the settling properties and the activity and the like) of the biological sludge, it is preferable to keep an appropriate sludge load, and, for example, granule sludge may be removed from the tank so as to keep the sludge load in a range of 0.05 to 0.60 kgBOD/MLSS/day or in a range of 0.1 to 0.5 kgBOD/MLSS/day.

For forming granule sludge using the semi-batch biological treatment tank 12, it is preferable to appropriately control the management of the settling time and the wastewater inflow ratio per batch. The settling time of biological sludge, which is calculated based on the distance between the water surface and the target sludge interface position and the settling rate of biological sludge, for example, may be set between 4 min/m and 15 min/m or may be set between 5 min/m and 10 min/m. The wastewater inflow ratio (the percentage of inflow water relative to the effective volume during reaction), for example, may be in a range of greater than or equal to 20% and less than or equal to 120% or may be in a range of greater than or equal to 40% and less than or equal to 120%.

The pH inside the semi-batch biological treatment tank 12 may be adjusted in a range of 6 to 9 suitable for typical biological treatment or may be adjusted in a range of 6.5 to 7.5. If the pH value falls outside this range, then a pH adjustment may be performed by using an acid or alkali. The dissolved oxygen (DO) in the semi-batch biological treatment tank 12 may be greater than or equal to 0.5 mg/L suitable for typical biological treatment or may be greater than or equal to 1 mg/L.

The continuous biological treatment tank 14 may have a configuration in which biological treatment is performed by, for example, a standard activated sludge process, or may be a system (a system including an anoxic treatment tank or an anaerobic treatment tank installed therein) that performs, for example, an A2O process (anaerobic-anoxic-oxic process) or an AO process (anaerobic-oxic process) or may be a device in which biological treatment is performed by a system that performs, for example, an oxidation ditch process or a step-feed multi-stage activated sludge process. It is also possible to use a device in which biological treatment is performed in the presence of a carrier made of, for example, polyurethane, plastic, or resin.

The continuous biological treatment tank 14 may be operated with, for example, a sludge concentration in the tank in a range of 2000 to 20,000 mg/L. To maintain the integrity (the settling properties and the activity and the like) of the biological sludge, the sludge load may be in a range of 0.05 to 0.6 kgBOD/MLSS/day or may be in a range of 0.1 to 0.5 kgBOD/MLSS/day.

In the illustrated embodiment of the present disclosure, the sedimentation tank 16 is used as a solid-liquid separation device for separating biological sludge from treated water, but the present disclosure is not limited to this embodiment, and, for example, a pressure flotation device, a filtration device, or a membrane separation device may be used.

### EXAMPLES

While the present disclosure will be described below in more specific detail by reference to an Example, the present disclosure is not limited to this Example.

Simulated wastewater treatment was performed using the device illustrated in FIG. 1. A simulated sewage containing a bonito extract and peptone as the main components (with an organic matter concentration of 100 to 150 mg/L and a total phosphorus concentration of 4 to 6 mg/L) was used as simulated wastewater. An AO process system that includes an anaerobic tank and an aerobic tank was used as the continuous biological treatment tank.

With the volume load of the continuous biological treatment tank being set to 0.4 to 0.7 kg/(m³·d) and the sludge retention time (SRT) of the continuous biological treatment tank being set to 20 days, the above-described simulated wastewater was continuously fed to the continuous biological treatment tank. Sludge returning from the sedimentation tank to the continuous biological treatment tank was at a flow rate that was 30% of the flow rate of the simulated wastewater. Suspended activated sludge was used as initially introduced sludge in the continuous biological treatment tank. Granule sludge formed by the semi-batch biological treatment tank was supplied to the continuous biological treatment tank in an amount of 0.24 g per day so that granule was present with a percentage of 2.3% relative to the sludge in the continuous biological treatment tank.

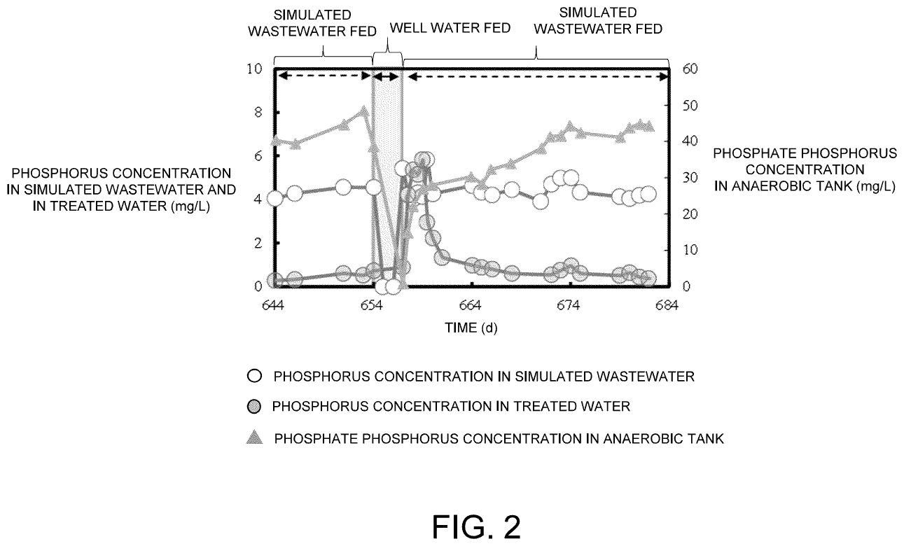

FIG. 2 is a graph illustrating the transitions in phosphorus concentration in simulated wastewater, phosphorus concentration in treated water discharged from a continuous biological treatment tank, and phosphate phosphorus concentration in an anaerobic tank as measured during a test period in an Example. Note that FIG. 2 illustrates concentration transitions from 644 days after the start of water flow. From day 644 to day 653 after the start of continuous water flow of simulated wastewater, the phosphate phosphorus concentration in the anaerobic tank transitioned among values approximately double the phosphorus concentration in the simulated wastewater, and the phosphorus concentration in the treated water transitioned among low concentrations. While not illustrated, the ORP in the anaerobic tank during the same period transitioned in a range of −150 mV to −200 mV. For two days from day 654 after the start of continuous water flow of simulated wastewater, the supply of simulated wastewater was stopped, and instead, well water (with an organic matter concentration of 0 mg/L and a total phosphorus concentration of 0 mg/L) was continuously fed. In response to the start of continuous water flow of well water to the continuous biological treatment tank, the phosphate phosphorus concentration in the anaerobic tank abruptly decreased, reaching 0 mg/L two days after the start of water flow of well water. While not illustrated, the ORP in the anaerobic tank during the same period increased, reaching 0 mV to 90 mV.

At the time when the phosphate phosphorus concentration in the anaerobic tank decreased and reached 0 mg/L, the supply of well water was stopped, and the continuous water flow of simulated wastewater was resumed with the supply volume of granule sludge to the continuous biological treatment tank per day being increased to double (0.48 g). Although the resumption of the continuous water flow of simulated wastewater caused a temporary increase in phosphorus concentration in the treated water up to 5.8 mg/L and deterioration in phosphorus removal performance in the continuous biological treatment tank, as the supply of an increased amount of granule sludge was continued, the phosphorus concentration in the treated water then quickly decreased to less than or equal to 1 mg/L. After the phosphorus concentration in the treated water decreased to less than or equal to 1 mg/L, the supply volume of granule sludge to the continuous biological treatment tank per day was reset to 0.24 g, but even after that, the phosphorus concentration in the treated water transitioned among values less than or equal to 1 mg/L.

The quickness in recovery of the phosphorus removal performance demonstrated by the Example is a result that is unachievable when the supply of a normal amount of granule sludge is continued without increasing the supply volume of granule sludge.

### REFERENCE SIGNS LIST

1 phosphorus-containing water treatment device
10 raw water tank
12 semi-batch biological treatment tank
14 continuous biological treatment tank
16 sedimentation tank
18 control device
20a, 20b water-to-be-treated pipe
22 first treated water pipe
24 second treated water pipe
26 third treated water pipe
28a to 28c sludge return pipe
30 sludge discharge pipe
32 water-to-be-treated pump
34a, 34b sludge return pump
36a to 36e electromagnetic valve
38 valve
40 sludge supply pipe
42 sludge supply pump

1. A phosphorus-containing water treatment method comprising:
subjecting phosphorus-containing water to biological treatment using biological sludge while continuously feeding the phosphorus-containing water to a continuous biological treatment tank;
forming granule sludge; and
supplying the granule sludge to the continuous biological treatment tank,
wherein, in the supplying the granule sludge, a supply volume of granule sludge which is to be supplied to the continuous biological treatment tank is controlled based on phosphorus removal performance in the continuous biological treatment tank.

2. The phosphorus-containing water treatment method according to claim 1, wherein the supply volume of granule sludge which is to be supplied to the continuous biological treatment tank per day is determined based on the phosphorus removal performance in the continuous biological treatment tank within a past predetermined period and a supply volume of granule sludge which has been supplied to the continuous biological treatment tank per day within the past predetermined period.

3. The phosphorus-containing water treatment method according to claim 1, wherein, during deterioration or estimated deterioration in phosphorus removal performance in the continuous biological treatment tank, the supply volume of granule sludge which is to be supplied to the continuous biological treatment tank is increased to be greater than during improvement in phosphorus removal performance in the continuous biological treatment tank.

4. The phosphorus-containing water treatment method according to claim 1, wherein the supply volume of granule sludge which is to be supplied to the continuous biological treatment tank per day is set based on the phosphorus removal performance in the continuous biological treatment tank in a range of 0-fold to 20-fold the supply volume of granule sludge which has been supplied to the continuous biological treatment tank per day on a preceding day.

5. A phosphorus-containing water treatment device comprising:
a continuous biological treatment tank configured to subject phosphorus-containing water to biological treatment using biological sludge while continuously feeding the phosphorus-containing water;
a granule sludge forming device configured to form granule sludge;
a sludge supply device configured to supply the granule sludge formed in the granule sludge forming device to the continuous biological treatment tank; and
a control device configured to control a supply volume of granule sludge which is to be supplied to the continuous biological treatment tank by the sludge supply device based on phosphorus removal performance in the continuous biological treatment tank.

6. The phosphorus-containing water treatment device according to claim 5, wherein the control device determines the supply volume of granule sludge which is to be supplied to the continuous biological treatment tank per day based on the phosphorus removal performance in the continuous biological treatment tank within a past predetermined period and a supply volume of granule sludge which has been supplied to the continuous biological treatment tank per day within the past predetermined period.

7. The phosphorus-containing water treatment device according to claim 5, wherein, during deterioration or estimated deterioration in phosphorus removal performance in the continuous biological treatment tank, the control device increases the supply volume of granule sludge which is to be supplied to the continuous biological treatment tank to be greater than during improvement in phosphorus removal performance in the continuous biological treatment tank.

8. The phosphorus-containing water treatment device according to claim 5, wherein the control device sets the supply volume of granule sludge which is to be supplied to the continuous biological treatment tank per day based on the phosphorus removal performance in the continuous biological treatment tank in a range of 0-fold to 20-fold the supply volume of granule sludge which has been supplied to the continuous biological treatment tank per day on a preceding day.
